(19) United States
(12) Patent Application Publication
(10) Pub. No.: US 2026/0148529 A1
(43) Pub. Date: May 28, 2026

(54) IMAGE PROCESSING METHOD, RECORDING MEDIUM, AND IMAGE PROCESSING DEVICE

(71) Applicant: Panasonic Intellectual Property Management Co., Ltd., Osaka (JP)

(72) Inventors: Yuto KITAGAWA, Osaka (JP); Taichi SATO, Kyoto (JP); Hisaji MURATA, Osaka (JP); Masahiro ISHII, Kanagawa (JP)

(21) Appl. No.: 19/121,770

(22) PCT Filed: Sep. 8, 2023
(86) PCT No.: PCT/JP2023/032840

§ 371 Date: Apr. 16, 2025

(30) Foreign Application Priority Data
Oct. 28, 2022 (JP) 2022-173631

(51) Int. Cl. G06V 10/774; G06T 7/11; G06V 10/72; G06V 10/74

(52) U.S. Cl. CPC G06V 10/774; G06T 7/11; G06V 10/72; G06V 10/761

(57) ABSTRACT

An image processing method according to one aspect of the present disclosure is executed by a computer. The image processing method includes: obtaining an original image that includes an object; selecting two or more small images that are effective for machine learning from among a plurality of small images generated by dividing the original image, based on degrees of learning contribution of the plurality of small images, the degrees of learning contribution each indicating a degree of effectiveness in machine learning of a different one of the plurality of small images; and outputting the two or more small images in display modes that are in accordance with the degrees of learning contribution of the two or more small images.

### TECHNICAL FIELD

The present disclosure relates to an image processing method, a program, and an image processing device.

### BACKGROUND ART

A conventional system is available which uses a learning model to diagnose an analysis object in an image. When training the learning model by machine learning, images are required as training data for machine learning.

Patent Literature (PTL) 1 discloses a program that cuts out a plurality of training images for training a discriminator from an input image, classifies the training images into one or more sets, and displays the training images. The user makes selections on the displayed training images to determine final training images.

### CITATION LIST

### Patent Literature

[PTL 1] Japanese Unexamined Patent Application Publication No. 2011-145791

### SUMMARY OF INVENTION

### Technical Problem

In order to train a learning model, such as a discriminator, by machine learning, a large number of images for machine learning are required. When the images for machine learning include a large number of images which are highly similar to each other, such problems occur that it takes long time for training and the data distribution differs from the original data distribution, which may lead to degradation of the discrimination performance of the discriminator. Therefore, it is desirable to be able to easily select images which allow effective machine learning, for example, with a small number of images for machine learning and an improved learning model performance.

The present disclosure provides an image processing method and the like that facilitates the selection of images effective for machine learning.

### Solution to Problem

An image processing method according to one aspect of the present disclosure is an image processing method executed by a computer. The image processing method includes: obtaining an original image that includes an object; selecting two or more small images that are effective for machine learning from among a plurality of small images generated by dividing the original image, based on degrees of learning contribution of the plurality of small images, the degrees of learning contribution each indicating a degree of effectiveness in machine learning of a different one of the plurality of small images; and outputting the two or more small images in display modes that are in accordance with the degrees of learning contribution of the two or more small images.

A program according to one aspect of the present disclosure is a program for causing a computer to execute the image processing method according to one aspect of the present disclosure.

An image processing device according one aspect of the present disclosure includes: an obtainer that obtains an original image that includes an object; a selector that selects two or more small images that are effective for machine learning from among a plurality of small images generated by dividing the original image, based on degrees of learning contribution of the plurality of small images, the degrees of learning contribution each indicating a degree of effectiveness in machine learning of a different one of the plurality of small images; and an outputter that outputs the two or more small images in display modes that are in accordance with the degrees of learning contribution of the two or more small images.

### Advantageous Effects of Invention

According to the present disclosure, it is possible to provide an image processing method and the like that facilitates the selection of images effective for machine learning.

### BRIEF DESCRIPTION OF DRAWINGS

FIG. 1 is a block diagram illustrating a configuration of an image processing device according to an embodiment.

FIG. 2 is a diagram for explaining a process performed by the image processing device according to the embodiment to determine the display modes of two or more small images.

FIG. 3 is a diagram for explaining a normal region and an abnormal region in an original image according to the embodiment.

FIG. 4 is a diagram for explaining a first example of an image output by the image processing device according to the embodiment.

FIG. 5 is a diagram for explaining a second example of the image output by the image processing device according to the embodiment.

FIG. 6 is a diagram for explaining a third example of the image output by the image processing device according to the embodiment.

FIG. 7 is a flowchart illustrating the procedures of the image processing device according to the embodiment.

### DESCRIPTION OF EMBODIMENT

Hereinafter, an embodiment according to the present disclosure will be described with reference to the drawings. The exemplary embodiment described below shows a specific example of the present disclosure. Therefore, the numerical values, shapes, materials, structural elements, the arrangement and connection of the structural elements and the like shown in the following exemplary embodiment are mere examples, and therefore do not limit the present disclosure. Among the structural elements in the following exemplary embodiment, those not recited in any one of the independent claims are described as optional structural elements.

The figures are schematically illustrated, and are not necessarily precise illustrations. In the figures, elements that are essentially the same share like reference signs, and duplicate description thereof is omitted or simplified.

### Embodiment

### Configuration

First, a configuration of image processing device 100 according to an embodiment will be described.

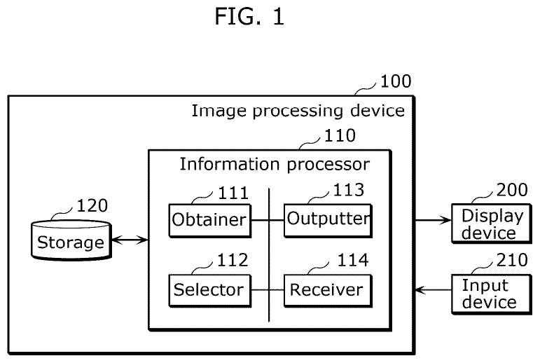

FIG. 1 is a block diagram illustrating a configuration of image processing device 100 according to an embodiment.

Image processing device 100 is a device that displays images (small images) based on an image (original image) generated by an imaging device, such as a camera, capturing an image of an object (workpiece). Specifically, image processing device 100 is an automatic training image selection device for selecting, from among a plurality of small images generated by dividing an original image, small images (hereinafter, also referred to as training images) for training a learning model by machine learning (artificial intelligence (AI) learning). The learning model is for determining whether the object in the original image includes a defect.

In machine learning, for example, a learning model is trained by machine learning using various training images obtained by capturing an image of an object and information indicating that each training image includes a defect or is a normal image (annotation information).

Training images include images that are effective for training the learning model by machine learning, i.e., images that improves the performance of the learning model even with a small number of images. On the other hand, some training images are not effective for training the learning model by machine learning. In particular, although there are a large number of candidates for selecting small images of normal regions that do not include defects, there is a problem that it is unclear which candidates are effective for machine learning.

In view of the above, image processing device 100 outputs training images that are effective for training the learning model, in such a way that the training images are easily understood by the user.

The term “performance” here is referred to, for example, the accuracy rate of correctly extracting defects or correctly determining that there are no defects when an original image is input to a learning model that has been trained by machine learning.

Image processing device 100 is, for example, a computer, such as a personal computer or a tablet terminal. Specifically, for example, image processing device 100 is realized by a communication interface for communicating with display device 200 and input device 210, a nonvolatile memory in which programs are stored, volatile memory that is a temporary storage area for executing programs, input and output ports for transmitting and receiving signals, and a processor that executes programs. The communication interface may be realized by, for example, a connector to which communication lines are connected to enable wired communication, or by an antenna and a wireless communication circuit to enable wireless communication.

Image processing device 100 includes information processor 110 and storage 120.

Information processor 110 is a processor that performs various processes executed by image processing device 100. For example, information processor 110 outputs a plurality of small images obtained by performing image processing on the obtained original image to display device 200, so that the plurality of small images are displayed on display device 200.

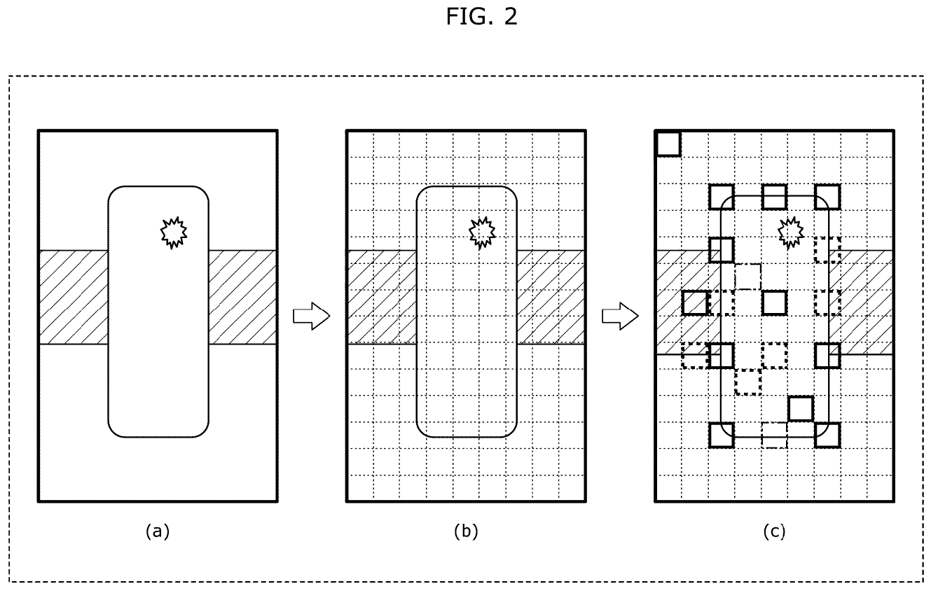

FIG. 2 illustrates a process performed by image processing device 100 according to the present embodiment to determine the display modes of two or more small images.

For example, information processor 110 obtains an original image including an object as illustrated in (a) of FIG. 2, and generates a plurality of small images as illustrated in (b) of FIG. 2 by dividing the obtained original image. In the example illustrated in (b) of FIG. 2, information processor 110 generates 14×9=126 small images from the original image. Moreover, as illustrated in (c) of FIG. 2, information processor 110 outputs two or more small images that are effective for machine learning in the display modes that are in accordance with the degrees of learning contribution of the two or more small images. The two or more small images that are effective for machine learning are selected based on the degrees of learning contribution of the plurality of small images. Each of the degrees of learning contribution indicates the degree of effectiveness in machine learning of a different one of the plurality of small images. In the example illustrated in (c) of FIG. 2, the display modes have been changed such that the frame borders of the small images having the degrees of learning contribution higher than or equal to a predetermined degree of learning contribution are enclosed by solid lines, dashed lines, or dash-dotted lines, unlike the small images having the degrees of learning contribution lower than the predetermined degree of learning contribution.

The phrase “effective for machine learning” means, for example, that the degree of learning contribution is higher than or equal to a predetermined degree of learning contribution. The predetermined degree of learning contribution may be arbitrarily determined.

The degree of learning contribution of each of the plurality of small images is determined based on, for example, a degree of similarity between a plurality of small images. The degree of similarity is calculated, for example, from the average value of the differences, such as luminance difference or color difference, between respective pixels at the same locations in two small images. For example, the degree of similarity is calculated to be lower as the average value is greater. The degree of learning contribution is determined based on the calculated degree of similarity. The degree of learning contribution is set, for example, such that as the degree of similarity is lower, the degree of learning contribution is higher.

For example, information processor 110 is realized by one or more processors.

Information processor 110 includes obtainer 111, selector 112, outputter 113, receiver 114, and storage 120.

Obtainer 111 is a processor that obtains an original image that includes an object. Specifically, obtainer 111 obtains an original image that includes a first object.

The object is an object to be inspected by the learning model. Obtainer 111 obtains, for example, an original image that includes an object as illustrated in (a) of FIG. 2 from an imaging device that captures an image of the object.

The object is, for example, an industrial product. In the present embodiment, the object is an electronic component, such as an integrated circuit (IC).

The object does not have to be an electronic component, but may be any object, such as a board.

The imaging device is a camera that produces an original image by capturing an image of an object. The imaging device is realized by, for example, a complementary metal oxide semiconductor (CMOS) image sensor.

Obtainer 111 may obtain an original image from a server device or the like via a communication interface included in image processing device 100.

Selector 112 is a processor that selects two or more small images that are effective for machine learning from among a plurality of small images generated by dividing the original image, based on the degrees of learning contribution of the plurality of small images. Each of the degrees of learning contribution indicates the degree of effectiveness in machine learning of a different one of the plurality of small images.

Selector 112 first generates a plurality of small images by dividing the original image. The way the original image is divided may be determined arbitrarily. For example, the number of the plurality of small images may be arbitrarily determined. Each of the plurality of small images may be rectangular or any other shape, such as triangular or circular. The plurality of small images may be identical to or different from each other in size and shape.

Next, selector 112 selects any one of the plurality of small images. The image selected here may be determined arbitrarily. In the example illustrated in (c) of FIG. 2, the top-most left small image illustrated in (c) of FIG. 2 is first selected from among the plurality of small images.

Next, selector 112 calculates the degree of similarity between the selected small image and each of a plurality of small images that have not been selected. Selector 112 further selects the image with the lowest degree of similarity from among the plurality of small images that have not been selected.

Selector 112 selects two or more small images that are effective for machine learning by repeating the process of selecting the small images and calculating the degrees of similarity (also referred to as the selection process) a predetermined number of times. In other words, selector 112 selects two or more small images by repeatedly performing the process of selecting one small image from among a plurality of small images excluding all the small images that have already been selected, based on the degree of similarity between each of the plurality of small images excluding all the small images that have been already selected and each of the small images that have been already selected. By the above process, for example, selector 112 selects, from among a plurality of small images, two or more small images that are effective for machine learning based on the degrees of learning contribution (more specifically, the degrees of similarity) of the plurality of small images. Each of the degrees of learning contribution indicates the degree of effectiveness in machine learning of a different one of the plurality of small images.

The predetermined number of times may be arbitrarily determined. For example, the predetermined number of times is determined based on a threshold value. For example, selector 112 selects two or more small images based on the degrees of similarity between the plurality of small images and a threshold value for the degrees of similarity. For example, when the threshold value is 0.2, selector 112 repeats the selection process until there are no more small images with calculated degrees of similarity that are less than or equal to 0.2.

The predetermined number of times may be arbitrarily determined by, for example, the user. For example, receiver 114 may receive information indicating a predetermined number of times or a threshold value from the user via input device 210.

For example, as the threshold value is greater, the number of two or more small images is greater. In other words, as the threshold value is greater, the number of small images selected by selector 112 is greater.

The number of threshold values may be one or plural. For example, the threshold value includes a first threshold value and a second threshold value that is greater than the first threshold value. Selector 112 selects, from among a plurality of small images, two or more small images including a first image having a degree of similarity less than the first threshold value and a second image having a degree of similarity greater than or equal to the first threshold value and less than the second threshold value.

For example, each of the two or more small images selected by selector 112 is an image of a normal region that does not include a defect of the object in the original image.

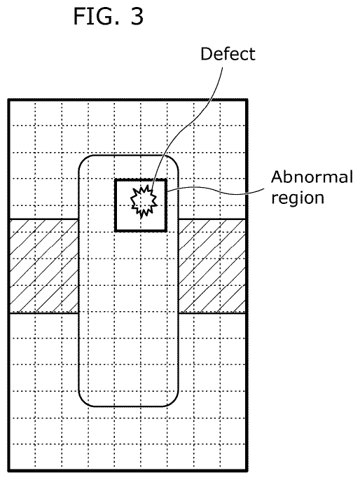

FIG. 3 is a diagram for explaining a normal region and an abnormal region in the original image according to the present embodiment. Specifically, FIG. 3 illustrates a plurality of small images obtained by dividing the original image.

The normal region is a region in the original image that is free of defects such as scratches, chips, stains, or dust adhesion. In the example illustrated in FIG. 3, the small images included in the “normal region” are the small images other than four small images enclosed by a solid line among the plurality of small images. On the other hand, the abnormal region is a region in the original image that includes such defects. In the example illustrated in FIG. 3, the small images included in the “abnormal region” are the four small images enclosed by a solid line among the plurality of small images.

For example, when selecting two or more small images, selector 112 does not select the small images of the abnormal region that includes defects, but selects two or more small images from among the small images of the normal region that does not include defects.

For example, the original image obtained by obtainer 111 is displayed on display device 200 by being output to display device 200 by outputter 113. The user inputs the location of the defect in the original image by operating input device 210. Receiver 114 receives the input. Selector 112 selects two or more small images from among the small images of the normal region that does not include defects, based on the input received by receiver 114. At this time, for example, it may be that selector 112 adds, to each of a plurality of small images, information indicating that the small image is normal (e.g., including no defect) or abnormal (e.g., including a defect), i.e., annotated information, based on the input, and stores the small images with the information in storage 120.

Outputter 113 is a processor that outputs the two or more small images selected by selector 112 in the display modes that are in accordance with the respective degrees of learning contribution. Specifically, outputter 113 changes the display mode of each of the two or more small images selected by selector 112 to the display mode that is in accordance with the degree of learning contribution of the small image, and outputs image information including the two or more small images with the changed display modes to display device 200. By doing so, two or more small images with the changed display modes are displayed on display device 200.

The phrase “two or more small images are output” means that an image including two or more small images may be output, and a plurality of small images that are generated by dividing the original image and including the two or more small images may be output, or the display modes of the portions of the original image corresponding to two or more small images may be changed before output.

The display mode may be determined arbitrarily. For example, outputter 113 outputs a plurality of small images after adding different decorations around or inside the two or more small images based on the degrees of learning contribution of the two or more small images.

Here, adding decorations includes, for example, adding a frame border around each of the two or more small images. For example, outputter 113 determines, based on the degree of learning contribution of each of the two or more small images, at least one display mode from among the width, the color, or the style of a border frame. The border style is a line style, such as a solid line, dotted line, dashed line, and dash-dotted line. For example, outputter 113 adds a frame border to each of the two or more small images, such that the width of the frame border is wider as the degree of learning contribution of the small image is higher, and the width of the frame border is narrower as the degree of learning contribution of the small image is lower.

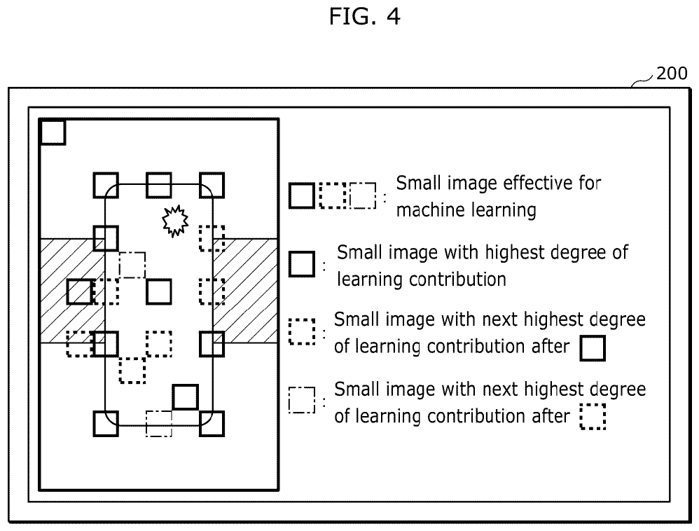

FIG. 4 is a diagram for explaining a first example of an image output by image processing device 100 according to the present embodiment. Specifically, FIG. 4 illustrates an example of image information output by outputter 113 and displayed on display device 200.

As illustrated in FIG. 4, for example, display device 200 displays an original image in which the portions in the original image corresponding to small images having degrees of learning contribution higher than or equal to a predetermined degree of learning contribution are enclosed by solid lines, dashed lines, or dash-dotted lines. For example, it is assumed that selector 112 selects, from among a plurality of small images, first images having degrees of similarity less than a first threshold value, second images having degrees of similarity greater than or equal to the first threshold value and less than a second threshold value, and third images having degrees of similarity greater than or equal to the second threshold value and less than a third threshold value. In this case, for example, outputter 113 changes the display modes of the two or more small images such that the portions in the original image corresponding to the first images (“small image with highest degree of learning contribution” illustrated in FIG. 4) are enclosed by solid lines, the portions in the original image corresponding to the second images (“small image with next highest degree of learning contribution after the solid square” illustrated in FIG. 4) are enclosed by dashed lines, and the portions in the original image corresponding to the third images (“small image with next highest degree of learning contribution after the dashed square” illustrated in FIG. 4) are enclosed by dashed-dotted lines. In this way, for example, outputter 113 outputs the first images and the second images in different display modes. In this example, outputter 113 outputs the original image in which the first images and the second images are displayed in different display modes. For example, outputter 113 outputs information indicating that the first images have the degrees of learning contribution higher than the degrees of learning contribution of the second images. The information is, for example, information that provides a description related to the degrees of learning contribution (i.e., the degrees of similarity) of two or more small images, such as “small image with highest degree of learning contribution” illustrated in FIG. 4.

For example, outputter 113 outputs information related to the two or more small images in descending order of the degree of learning contribution. In the example illustrated in FIG. 4, outputter 113 outputs the image information such that the descriptions for the two or more small images (e.g., “small images with highest degree of learning contribution”) are arranged in descending order of the degree of learning contribution from the top of the image displayed on display device 200

The phrase “output information related to two or more small images in descending order of the degree of learning contribution” may include, for example, displaying the two or more small images while temporally changing in sequence the solid lines, dashed lines, and dash-dotted lines enclosing the two or more images illustrated in FIG. 4 in this order. For example, it may be that, among the solid lines, dashed lines, and dash-dotted lines, only solid lines are displayed, only dashed lines are displayed after a predetermined period, only dash-dotted lines are displayed after another predetermined period, and these displays are repeatedly changed. In this way, information related to the two or more small images may include, for example, information describing the two or more small images and the display modes, such as frame borders, of the two or more small images. The phrase “in descending order” may be a spatial order, such as from top, or a temporal order.

Moreover, adding decorations to the two or more small images includes, for example, correcting at least one of the hue, saturation, or brightness in each of the two or more small images. For example, outputter 113 makes corrections that attract the eye of the user by correcting the colors of the two or more small images to be closer to expansive colors such as warm colors, increasing the saturations of the two or more small images, or increasing the brightness of the two or more small images. Of course, outputter 113 may change the display modes by adding a frame border around each of the two or more small images and correcting the images, such as correcting the hue. For example, a change in the display mode, such as hue correction, may be performed on small images that have not been selected by selector 112 (i.e., small images other than the two or more small images) from among a plurality of small images. For example, small images that have not been selected by selector 112 among a plurality of small images may be corrected by reducing the brightness to make the images less visible.

Receiver 114 is a processor that receives user operations. Receiver 114 receives user operations via, for example, input device 210. Receiver 114, for example, receives input of location information indicating the location of an abnormal region (or defect) in the original image. The user, for example, views the original image or small images displayed on display device 200, and inputs the location of the abnormal region in the original image or the small images, or small images including defects, using input device 210. Receiver 114, for example, receives such an input as location information.

It may be that receiver 114 receives a first command indicating a first threshold value or a second threshold value, and outputter 113 determines the display modes of the two or more small images based on the first command received by receiver 114 and outputs the two or more small images. In other words, the display modes of the two or more images in the image information displayed on display device 200 may be changed based on the first command.

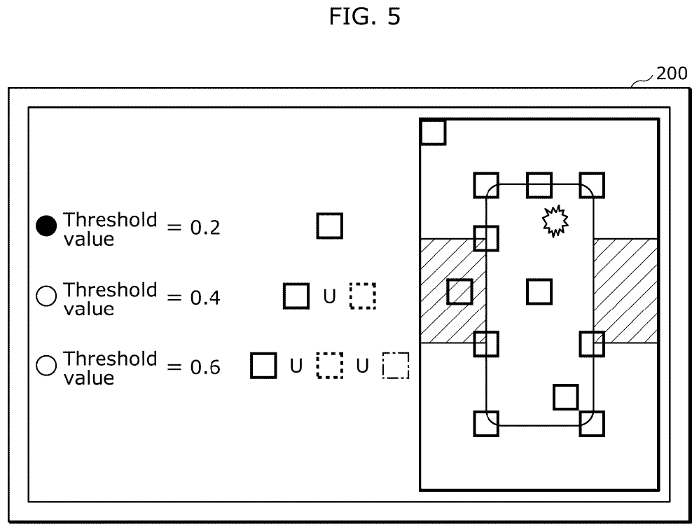

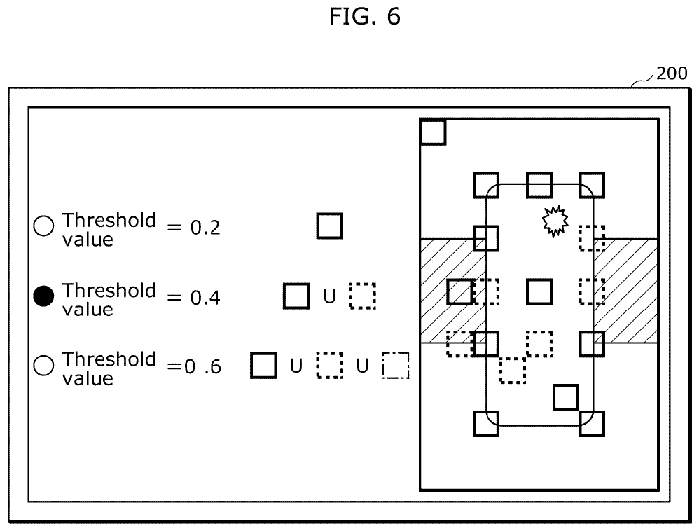

FIG. 5 is a diagram for explaining a second example of the image output by image processing device 100 according to the embodiment. FIG. 6 is a diagram for explaining a third example of the image output by image processing device 100 according to the embodiment. In the examples illustrated in FIG. 5 and FIG. 6, in a similar manner to the first example in FIG. 4, it is assumed that selector 112 selects, from among a plurality of small images, first images having degrees of similarity less than the first threshold value, second images having degrees of similarity greater than or equal to the first threshold value and less than the second threshold value, and third images having degrees of similarity greater than or equal to the second threshold value and less than the third threshold value. In this example, the first threshold value is “threshold value=0.2”, the second threshold value is “threshold value=0.4”, and the third threshold value is “threshold value =0.6”.

In the second example, outputter 113 first outputs image information indicating small images that correspond to the first images and have frame borders. With this, as illustrated in FIG. 5, display device 200 displays the original image with frame borders at the locations corresponding to the first images that are the small images selected by selector 112 under the condition of threshold=0.2.

Next, it is assumed, for example, that receiver 114 receives the selection of threshold value=0.4 as a first command. In this case, outputter 113 outputs image information indicating small images that correspond to the first images and the second images and have frame borders. With this, as illustrated in FIG. 6, display device 200 displays the original image in which solid frame borders are added to the portions corresponding to the first images that are the small images selected by selector 112 under the condition of threshold=0.2, and dashed frame borders are added to the portions corresponding to the second images that are the small images that have not been selected by selector 112 under the condition of threshold=0.2 but have been selected by selector 112 under the condition of threshold=0.4.

For example, the user selects small images to be used for machine learning from among two or more small images, by selecting the threshold values in the manner described above. For example, when the user selects threshold value=0.2, the first images are determined as the training images to be used for machine learning. For example, when the user selects threshold value=0.4, the first images and the second images are determined as the training images to be used for machine learning. For example, when receiver 114 receives the first command, outputter 113 determines training images from among two or more small images based on the first command, and stores, in storage 120, information indicating that the determined images are the training images. For example, when receiver 114 receives a command for machine learning, outputter 113 selects training images based on the information, and inputs the selected training images into the learning model to train the learning model by machine learning.

The determination of the training images from among a plurality of small images may be made arbitrarily.

For example, receiver 114 receives a second command indicating, among two or more small images ranked according to the degrees of learning contribution of the two or more small images, how many small images, in descending order of degrees of learning contribution, are to be used for machine learning, starting with a small image having a highest degree of learning contribution. The training images may be determined in this way. Selector 112 may, for example, calculate the degrees of similarity for all small images by repeating the above selection process for all small images, and calculate the degrees of learning contribution based on the calculated degrees of similarity. When calculating the degrees of learning contribution for all small images, selector 112 may first calculate the degrees of learning contribution for all small images and then select two or more small images subject to the display mode change.

Moreover, for example, outputter 113 adds frame boarders to two or more small images such that as the degree of learning contribution is higher, the width of the frame boarder is wider and as the degree of learning contribution is lower, the width of the frame boarder is narrower. In this case, when receiver 114 receives a third command indicating the width of the frame boarder, the small image decorated with a frame boarder having a width wider than the width of the frame border indicated by the third command may be determined to be used for machine learning from among the two or more small images.

Obtainer 111, selector 112, outputter 113, and receiver 114, for example, may be realized by a common processor or by independent processors.

Storage 120 is a storage device that stores, for example, programs executed by obtainer 111, selector 112, outputter 113, receiver 114, and the like to perform their respective processes, information necessary for the processes, and inspection images. Storage 120 is realized by, for example, a hard disk drive (HDD) and/or a semiconductor memory.

Display device 200 is a display that displays images based on the control of image processing device 100 (more specifically, outputter 113). Display device 200, for example, displays a plurality of small images (i.e., original image) that include two or more small images. Display device 200 is realized by, for example, a display device, such as a liquid crystal panel or an organic electroluminescent (EL) panel.

Input device 210 is a user interface that receives user operations. Input device 210 can be realized by, for example, a mouse, keyboard, touch panel and/or hardware buttons.

Display device 200 and input device 210 may be realized integrally as a touch panel display or the like.

### Procedures

Next, the procedures of image processing device 100 according to the embodiment will be described.

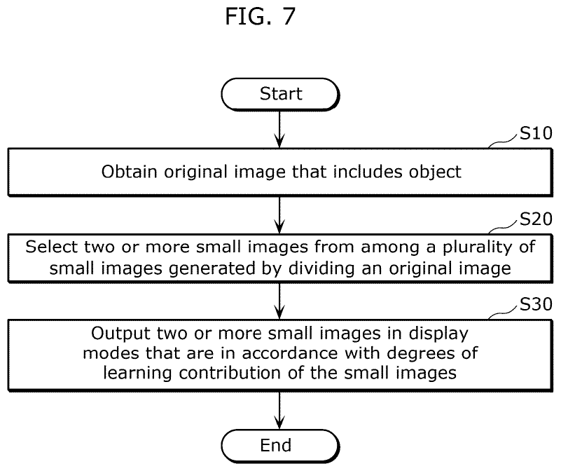

FIG. 7 is a flowchart illustrating the procedures of image processing device 100 according to the embodiment.

First, obtainer 111 obtains an original image that includes an object (S10). For example, obtainer 111 obtains the original image from a camera (not illustrated), via a communication interface or the like included in image processing device 100.

The original image may be stored, for example, in storage 120. In this case, obtainer 111, for example, obtains the original image from storage 120.

Next, selector 112 selects two or more small images that are effective for machine learning from among a plurality of small images generated by dividing the original image, based on the degrees of learning contribution of the plurality of small images (S20). Each of the degrees of learning contribution indicates the degree of effectiveness in machine learning of a different one of the plurality of small images. Specifically, selector 112 generates a plurality of small images by dividing the original image obtained by obtainer 111. Next, selector 112 selects any one of the plurality of small images. In the above example, for example, the top-most left small image illustrated in (c) of FIG. 2 is first selected from among the plurality of small images. Next, selector 112 calculates the degree of similarity between the selected small image and each of the plurality of small images that have not been selected. Selector 112 calculates the degree of similarity between each of the small images that have already been selected and each of the small images that have not yet been selected. Selector 112 selects two or more small images that are effective for machine learning by repeating these processes a predetermined number of times. The predetermined number of times may be arbitrarily determined. For example, in the above example, the predetermined number of times is determined based on a threshold value.

The degree of similarity of each small image may be calculated from, for example, the average value of the degrees of similarity between the small images.

Outputter 113 then outputs the two or more small images that have been selected by selector 112 in the display modes that are in accordance with the degrees of learning contribution of the two or more small images (S30). Specifically, outputter 113 displays the two or more small images selected by selector 112 on display device 200 in the display modes that are in accordance with the degrees of learning contribution of the two or more small images.

Outputter 113 may train the learning model by machine learning by outputting, to the learning model, the two or more small images selected by selector 112.

### Advantageous Effects, etc.

Exemplary technologies that can be obtained from the disclosure of this description will be presented below, and the advantageous effects and the like that can be obtained from the exemplary techniques will be described below.

Technology 1 is an image processing method executed by a computer. The image processing method includes: obtaining (S10) an original image that includes an object; selecting (S20) two or more small images that are effective for machine learning from among a plurality of small images generated by dividing the original image, based on degrees of learning contribution of the plurality of small images, the degrees of learning contribution each indicating a degree of effectiveness in machine learning of a different one of the plurality of small images; and outputting (S30) the two or more small images in display modes that are in accordance with the degrees of learning contribution of the two or more small images.

Machine learning that uses images as input requires a large number of images as training data. Here, a plurality of images with similar image features, such as images in which the shapes, arrangements, and the like of the objects are identical to each other, are less effective for machine learning than a plurality of images with no similar image features. Therefore, a plurality of images with no similar image features can be used for machine learning, so that machine learning can be effectively performed, for example, to produce appropriate output even with a small number of training images for machine learning. In view of the above, in the image processing method according to one aspect of the present disclosure, among a plurality of small images generated by dividing the original image, two or more small images that are effective for machine learning are output in the display modes that are in accordance with the degrees of learning contribution of the two or more small images, based on the degrees of learning contribution of the plurality of small images. The degrees of learning contribution each indicate the degree of effectiveness in machine learning of a different one of the plurality of small images. With this, the small images can be displayed in the display modes that are in accordance with the degrees of learning contribution. Therefore, it is easy for the user to select images that are effective for machine learning.

Technology 2 is the image processing method according to technology 1, in which the degrees of learning contribution of the plurality of small images are determined based on degrees of similarity between the plurality of small images, and in the selecting, the two or more small images are selected based on the degrees of similarity between the plurality of small images and a threshold value for the degrees of similarity.

In this way, the image processing method according to one aspect of the present disclosure is an automatic training image selection method that uses the degrees of similarity. The image processing method selects small images that are effective for learning based on the degrees of similarity between the small images.

With this, it is possible to automatically select small images which are not similar to each other, i.e., which have low degrees of similarity, from among a plurality of candidates (i.e., a plurality of small images). Therefore, it is possible to appropriately select two or more small images that are effective for machine learning. By using the two or more small images selected in this way for machine learning, the discrimination performance of the learning model can be improved with a smaller number of small images.

Technology 3 is the image processing method according to technology 2, in which each of the two or more small images is an image of a normal region that does not include a defect of the object in the original image.

There are a large number of images of the normal region, and it is unclear which images of the normal region are effective for machine learning. Therefore, determining which images are effective for machine learning requires trial and error. On the other hand, images of the abnormal region are more localized and have clearer image features than images of the normal region. Therefore, it does not require that much trial and error to determine images that are effective for machine learning. Therefore, the image processing method according to one aspect of the present disclosure is particularly effective for images of the normal region.

Technology 4 is the image processing method according to technology 2 or 3, in which a total number of the two or more small images is greater as the threshold value is greater.

In other words, as the threshold value is greater, the number of two or more small images displayed on display device 200 is greater.

As described above, it is considered that as the degree of similarity between images is lower, the images are more effective for machine learning, i.e., the degrees of learning contribution of the images are higher. Therefore, as the threshold value set is greater, the number of two or more small images selected is greater. Accordingly, for example, when the user has a desire to select images to be used for machine learning from among a large number of images, a higher threshold value can be set, so that the display modes can be changed such that the images effective for machine learning can be easily understood by the user.

Technology 5 is the image processing method according to any one of technologies 2 to 4, in which, in the selecting, the two or more small images are selected by repeatedly selecting one small image from among the plurality of small images excluding all of one or more selected small images that have already been selected, based on a degree of similarity between each of the one or more selected small images and each of the plurality of small images excluding the one or more selected small images.

In other words, the degrees of similarity between the selected small images and unselected small images are calculated, and the small images effective for the next training are selected.

With this, images having low degrees of similarity to the selected images are repeatedly selected, so that images having low degrees of similarity to each other can be easily selected without a need to calculate all the degrees of similarity of a plurality of small images.

Technology 6 is the image processing method according to any one of technologies 2 to 5, in which the threshold value includes a first threshold value and a second threshold value that is greater than the first threshold value, in the selecting, the two or more small images selected from among the plurality of small images include a first image having a degree of similarity that is less than the first threshold value and a second image having a degree of similarity that is greater than or equal to the first threshold value and less than the second threshold value, and in the outputting, the first image and the second image are output in different display modes.

This makes it easy to classify images that have close degrees of similarity according to each threshold value.

Technology 7 is the image processing method according to technology 6 that further includes: receiving a first command that indicates the first threshold value or the second threshold value. In the outputting, the display modes of the two or more small images are determined based on the first command received in the receiving, and the two or more small images are output in the display modes determined.

For example, in the outputting (first output step), combinations of a threshold value and a frame border corresponding to the threshold value are first output (displayed), as illustrated in FIG. 4. Next, in the receiving step, a selection of the threshold value desired by the user is received from the user. Next, in the outputting (second output step), the display mode (e.g., frame border) of the small image is changed based on the selection (threshold) received in the receiving step. For example, when the image illustrated in FIG. 4 is output in the first output step and the selection of threshold=0.4 is received in the receiving step, the image illustrated in FIG. 5 is output in the second output step. With this, for example, small images having the degrees of learning contribution that the user wants to check can be output easily. For example, small images having the degrees of learning contribution lower than the threshold value selected in this way are used for machine learning of the learning model. The selection of machine-learning images performed by a computer based on threshold values uses objective evaluation image similarity values, which may differ from the degrees of similarity of the images as seen by humans. In this way, for example, the images used for machine learning are finally selected based on the threshold value selected by the user, thus filing the gap between the computer determination and human determination.

Technology 8 is the image processing method according to any one of technologies 2 to 7, in which the threshold value includes a first threshold value and a second threshold value that is greater than the first threshold value, in the selecting, the two or more small images selected from among the plurality of small images include a first image having a degree of similarity that is less than the first threshold value and a second image having a degree of similarity that is greater than or equal to the first threshold value and less than the second threshold value, and the outputting includes outputting information indicating that the first image has a degree of learning contribution that is higher than a degree of learning contribution of the second image.

In other words, the small images selected when the threshold value for the degree of similarity is small are displayed on display device 200 as small images with high degrees of learning contribution.

With this, since images selected based on a relatively small threshold value indicate images that are not similar to each other, small images with identical feature values can be easily selected by the user as images to be used for machine learning, i.e., images with high degrees of learning contribution. In other words, the smaller the threshold value, the less similar the selected small images are to each other, and the more likely it is that a plurality of small images with the same label (e.g., a given feature such as luminance) and various feature values that differ from each other with respect to the label are selected by the user as training images.

Technology 9 is the image processing method according to any one of technologies 1 to 8, further includes: receiving a second command indicating, among the two or more small images ranked according to the degrees of learning contribution of the two or more small images, how many small images, in descending order of degrees of learning contribution, are to be used for machine learning, starting with a small image having a highest degree of learning contribution.

This allows the user to easily select images to be used for machine learning.

Technology 10 is the image processing method according to any one of technologies 1 to 9, in which, in the outputting, the plurality of small images are output after adding different decorations around or inside the two or more small images according to the degrees of learning contribution of the two or more small images.

With this, it is possible to notify the user of the degree of learning contribution of each small image by using decorations.

Technology 11 is the image processing method according to technology 10, in which the adding of different decorations includes adding a frame border around each of the two or more small images, and the outputting includes determining at least one display mode from among a width, a color, and a style of the frame border, based on the degree of learning contribution of each of the two or more small images.

Technology 12 is the image processing method according to technology 10 or 11, in which the adding of different decorations includes correcting at least one of a hue, a saturation, or a brightness of each of the two or more small images.

With these, the user is capable of easily understanding the degree of learning contribution of each of small images simply by looking at each small image decorated to indicate the degree of learning contribution.

Technology 13 is the image processing method according to technology 11, in which, in the outputting, the width of the frame border added to each of the two or more small images is wider as the degree of learning contribution of the small image is higher and is narrower as the degree of learning contribution of the small image is lower. The image processing method further includes: receiving a third command that indicates the width of the frame border to determine, from among the two or more small images, a small image decorated with a frame border having a width wider than the width of the frame border indicated by the third command as an image to be used for machine learning.

With this, the user is capable of easily understanding the degree of learning contribution of each of small images simply by looking at each small image decorated to indicate the degree of learning contribution, and easily selecting the small images to be used for machine learning.

Technology 14 is the image processing method according to any one of technologies 1 to 13, in which the object is an industrial product.

Machine learning that uses images is used for various applications, for example, to inspect industrial products, such as components of electrical devices and to identify people. Industrial products are different from people, for example, because same objects are produced mechanically. Even when images include different objects, if the objects are the same industrial products, many images are highly similar to each other. Moreover, in order to facilitate manufacturing, unnecessary processes are rarely performed, and there may be many portions having high degrees of similarity within a single image. Therefore, the image processing method according to one aspect of the present disclosure is particularly effective when images that are likely to include highly similar images, such as industrial products, are used.

Technology 15 is the image processing method according to any one of technologies 1 to 14, in which the outputting includes outputting information related to the two or more small images in descending order of the degrees of learning contribution of the two or more small images.

This makes it easier for the user to select images that are effective for machine learning.

Technology 16 is a program for causing a computer to execute the image processing method according to any one of technologies 1 to 15.

With this, the same advantageous effects as the image processing method according to one aspect of the present disclosure are achieved.

Technology 17 is image processing device 100 that includes: obtainer 111 that obtains an original image that includes an object; selector 112 that selects two or more small images that are effective for machine learning from among a plurality of small images generated by dividing the original image, based on degrees of learning contribution of the plurality of small images, the degrees of learning contribution each indicating a degree of effectiveness in machine learning of a different one of the plurality of small images; and outputter 113 that outputs the two or more small images in display modes that are in accordance with the degrees of learning contribution of the two or more small images.

With this, the same advantageous effects as the image processing method according to one aspect of the present disclosure are achieved.

Some general and specific aspects may be implemented using a system, a method, an integrated circuit, a computer program, or a non-transitory computer-readable recording medium such as a CD-ROM, or any combination of systems, methods, integrated circuits, computer programs, or non-transitory computer-readable recording

### Other Embodiments

Although the embodiment has been described above, the present disclosure is not limited to the embodiment.

In the embodiment described above, image processing device 100 is realized as a single device, but may be realized by a plurality of devices. When the image processing device is realized by a plurality of devices, the structural elements included in the image processing device described in the embodiment may be distributed to the devices in any manner.

Moreover, in the embodiment, the processes executed by a specific processor may be executed by another processor. The order of the plurality of processes may be changed or a plurality of processes may be executed in parallel.

Moreover, each of the structural elements (each processor) in the above described embodiment may be realized by executing a software program suitable for the structural element. Each of the structural elements may be realized by means of a program executing unit, such as a central processing unit (CPU) or a processor, reading and executing the software program recorded on a recording medium such as a hard disk or a semiconductor memory.

Each structural element may be realized by hardware. Each structural element may be realized by a circuit (or integrated circuit). These circuits may form one circuit as a whole, or may be separate circuits. These circuits may be general-purpose circuits or dedicated circuits.

Some general and specific aspects according to the present disclosure may be implemented using a system, a device, a method, an integrated circuit, a computer program, or a non-transitory computer-readable recording medium such as a CD-ROM, or any combination of systems, devices, methods, integrated circuits, computer programs, or recording media.

For example, the present disclosure may be realized as an image processing method executed by a computer such as an image processing device. The present disclosure may be realized as a program for causing the computer to execute such an image processing method, or a non-transitory computer-readable recording medium in which such a program is recorded.

In addition, a form obtained by making various modifications conceivable by those skilled in the art to each embodiment, and a form realized by arbitrarily combining the structural elements and functions in each embodiment without departing from the gist of the present disclosure are also included in the present disclosure.

### INDUSTRIAL APPLICABILITY

The present disclosure is useful as an image processing device that presents images to a user.

### REFERENCE SIGNS LIST

100 image processing device

110 information processor

111 obtainer

112 selector

113 outputter

114 receiver

120 storage

200 display device

210 input device

1. An image processing method executed by a computer, the image processing method comprising:
obtaining an original image that includes an object;
selecting two or more small images that are effective for machine learning from among a plurality of small images generated by dividing the original image, based on degrees of learning contribution of the plurality of small images, the degrees of learning contribution each indicating a degree of effectiveness in machine learning of a different one of the plurality of small images; and
outputting the two or more small images in display modes that are in accordance with the degrees of learning contribution of the two or more small images.

2. The image processing method according to claim 1,
wherein the degrees of learning contribution of the plurality of small images are determined based on degrees of similarity between the plurality of small images, and
in the selecting, the two or more small images are selected based on the degrees of similarity between the plurality of small images and a threshold value for the degrees of similarity.

3. The image processing method according to claim 2,
wherein each of the two or more small images is an image of a normal region that does not include a defect of the object in the original image.

4. The image processing method according to claim 2,
wherein a total number of the two or more small images is greater as the threshold value is greater.

5. The image processing method according to claim 2,
wherein, in the selecting, the two or more small images are selected by repeatedly selecting one small image from among the plurality of small images excluding all of one or more selected small images that have already been selected, based on a degree of similarity between each of the one or more selected small images and each of the plurality of small images excluding the one or more selected small images.

6. The image processing method according to claim 2,
wherein the threshold value includes a first threshold value and a second threshold value that is greater than the first threshold value,
in the selecting, the two or more small images selected from among the plurality of small images include a first image having a degree of similarity that is less than the first threshold value and a second image having a degree of similarity that is greater than or equal to the first threshold value and less than the second threshold value, and
in the outputting, the first image and the second image are output in different display modes.

7. The image processing method according to claim 6, further comprising:
receiving a first command that indicates the first threshold value or the second threshold value,
wherein, in the outputting, the display modes of the two or more small images are determined based on the first command received in the receiving, and the two or more small images are output in the display modes determined.

8. The image processing method according to claim 2,
wherein the threshold value includes a first threshold value and a second threshold value that is greater than the first threshold value,
in the selecting, the two or more small images selected from among the plurality of small images include a first image having a degree of similarity that is less than the first threshold value and a second image having a degree of similarity that is greater than or equal to the first threshold value and less than the second threshold value, and
the outputting includes outputting information indicating that the first image has a degree of learning contribution that is higher than a degree of learning contribution of the second image.

9. The image processing method according to claim 1, further comprising:
receiving a second command indicating, among the two or more small images ranked according to the degrees of learning contribution of the two or more small images, how many small images, in descending order of the degrees of learning contribution, are to be used for machine learning, starting with a small image having a highest degree of learning contribution.

10. The image processing method according to claim 1,
wherein, in the outputting, the two or more small images are output after adding different decorations around or inside the two or more small images according to the degrees of learning contribution of the two or more small images.

11. The image processing method according to claim 10,
wherein the adding of different decorations includes adding a frame border around each of the two or more small images, and
the outputting includes determining at least one display mode from among a width, a color, and a style of the frame border, based on the degree of learning contribution of each of the two or more small images.

12. The image processing method according to claim 10,
wherein the adding of different decorations includes correcting at least one of a hue, a saturation, or a brightness of each of the two or more small images.

13. The image processing method according to claim 11,
wherein, in the outputting, the width of the frame border added to each of the two or more small images is wider as the degree of learning contribution of the small image is higher and is narrower as the degree of learning contribution of the small image is lower, and
the image processing method further comprises:
receiving a third command that indicates the width of the frame border to determine, from among the two or more small images, a small image decorated with a frame border having a width wider than the width of the frame border indicated by the third command as an image to be used for machine learning.

14. The image processing method according to claim 1,
wherein the object is an industrial product.

15. The image processing method according to claim 1,
wherein the outputting includes outputting information related to the two or more small images in descending order of the degrees of learning contribution of the two or more small images.

16. A non-transitory computer-readable recording medium having recorded thereon a computer program for causing a computer to execute the image processing method according to claim 1.

17. An image processing device comprising:
an obtainer that obtains an original image that includes an object;
a selector that selects two or more small images that are effective for machine learning from among a plurality of small images generated by dividing the original image, based on degrees of learning contribution of the plurality of small images, the degrees of learning contribution each indicating a degree of effectiveness in machine learning of a different one of the plurality of small images; and
an outputter that outputs the two or more small images in display modes that are in accordance with the degrees of learning contribution of the two or more small images.
